(19) United States
(12) Patent Application Publication
(10) Pub. No.: US 2007/0254981 A1
(43) Pub. Date: Nov. 1, 2007

(54) Layered nanoparticles with controlled energy transfer between dopants

(75) Inventors: Jeffrey R. DiMaio, Seneca, SC (US); John Ballato, Clemson, SC (US)

Correspondence Address: DORITY & MANNING, P.A., POST OFFICE BOX 1449, GREENVILLE, SC, 29602-1449, US

(73) Assignee: Clemson University

(21) Appl. No.: 11/412,420

(22) Filed: Apr. 27, 2006

(51) Int. Cl. C08K 9/00

(52) U.S. Cl. 523/200; 428/403

(57) ABSTRACT

Disclosed are layered nanoparticles including multiple dopants constrained in discrete layers of the particles. Through predetermination of the architecture of the nanoparticles, energy transfer between the active ions can be controlled. Active ions can be provided in discrete sections of the nanoparticles so as to allow complete, partial, or no energy transfer between the optically active ions. In one embodiment, the emission spectra of a single nanoparticle can be equivalent to the spectrum of a blend of singularly doped nanoparticles, providing for composite materials with improved homogeneousness and multiple emissions from a single excitation wavelength. The layered nanoparticles can be, for example, core/shell nanoparticles.

### BACKGROUND OF THE INVENTION

Over the last few decades, mankind has considerably expanded the understanding of optical energy. This growing understanding has led to an increasing ability to harness and control light, which has in turn led to improvements in a wide variety of different technologies. For instance, the recognition of the enhanced transparency of halide salts over oxide materials opened up the possibility of utilizing these materials in various low-loss applications. Moreover, the possibility of doping such low-loss materials with luminescent ions, and in particular, rare earth ions, has led to the development of materials with tailored emission properties (i.e., spectral engineering).

Unfortunately, early attempts at forming spectrally engineered emissive materials proved difficult and uneconomical. For instance Jones, et al. (J. Crystal Growth, 2, 361-368, 1968) disclosed that the concentration of rare earth ions in Lanthanum Fluoride (LaF₃) crystals grown from a melt is limited to levels ranging from 25 mole percent for samarium (Sm) to less than 1 mole percent for ytterbium (Yb). Only cerium (Ce), praseodymium (Pr) and neodymium (Nd) are disclosed by Jones, et al. as being completely soluble in LaF₃. Kudryavtseva, et al. (Sov. Phys. Crystallogr., 18(4), 531, 1974) disclosed that higher solubility can be obtained when melt-grown crystals are quenched into water. The improved solubilities in LaF₃ by use of this method ranged from 65 mole percent for Sm down to 5 mole percent for lutetium (Lu).

Improved processing techniques have been developed for forming emissive materials with tailored spectra. For example, Riman, et al. (U.S. Pat. No. 6,699,406) and Riman, et al. (U.S. Patent Application Publication No. 2004/0174917), both of which are incorporated herein by reference, disclose composite materials including optically transparent inorganic nanoparticles doped with active ions that can absorb light and emit at other wavelengths. The active ions entirely reside in the low-phonon energy environment of the fluoride nanoparticles, and are therefore not influenced by the ions of other particles.

While such advances show significant improvement in the art, further room for improvement exists. For instance, while the lanthanides possess the energy bands to enable discrete emissions from the ultraviolet (UV) to the IR, it is often preferred that the ions not be co-doped within a single host due to ion-ion interactions which result in a more selective emission. This energy transfer can be undesirable, for instance when designing materials for optical applications requiring broadband emissive performances, such as optical amplifiers, white light sources, and sensors. The current technology for restricting energy transfer between active ions uses particles which are singularly doped with different active ions such that the dopants are physically constrained to separate hosts. Such methods provide little or no control over the energy transfer between dopants, however. Materials that could provide controlled energy transfer between multiple active ions to provide zero, partial, or complete energy transfer from a donor ion to an acceptor ion according to a predetermined specification would be of great benefit to the art.

### SUMMARY OF THE INVENTION

In one embodiment, the present invention is directed to layered nanoparticles in which energy transfer between dopants can be controllably determined. A nanoparticle of the invention can include a first optically active ion within a first layer of the nanoparticle and a second optically active ion within a second layer of the nanoparticle. For instance, the layered nanoparticle can be a core/shell nanoparticle.

Active ions can be, for example, rare earth elements. For instance, a rare earth element can be contained within a layer of the nanoparticle as a dopant of an optically transparent base material, such as a halide salt. In such an embodiment, optically transparent base materials of different layers can be the same or different, as desired.

Through the predetermined location of the first layer and the second layer with respect to one another, energy transfer between the optically active ions can be controlled. For example, two layers including different optically active ions can be immediately adjacent to one another and the energy transfer between the ions can be large. In another embodiment, an optically passive layer can be located between the two layers. The thickness of this optically passive layer can control the amount of energy transfer between the two active ions that are separated by the passive layer. For instance, an optically passive layer can be located between two layers, each of which contain different optically active ions, and the energy transfer between the two optically active ions can be less than that of a co-doped particle, e.g., partial energy transfer. In another embodiment, one or more intervening layers can completely prevent energy transfer, i.e., zero energy transfer between the active ions.

In another embodiment, the present invention is directed to composite materials include the layered nanoparticles. For instance, a composite material can include layered nanoparticles as described above encapsulated in a matrix. Matrix materials of the composites can include, for example, optically transparent crystalline materials, glass, polymeric materials, and the like.

In yet another embodiment, the invention is directed to methods of forming the disclosed layered nanoparticles. One such method includes combining in an aqueous solution an anion, a first cation (e.g., a metal cation of a halide salt), and a second optically active cation (e.g., a rare earth element), and reacting the anion, the first cation, and the second cation to form the first layer. A second layer can then be formed in a similar fashion, i.e., via solution reaction between the anion, a third cation and a fourth optically active cation, where the third cation may be the same or different from the first cation, and the second cation, which is optically active, may be the same or different from the fourth cation, which is also optically active.

In one embodiment, the anion can be a halogen, and a doped halide salt base material can be directly formed from the solution reaction. In another embodiment, the anion can be a hydroxide, and the layered nanoparticle can be formed as a hydrous oxide layered nanoparticle. In this particular embodiment, the hydrous oxide layered nanoparticles can be halogenated, for instance via reaction with a halide gas.

Additional layers can be grown on the nanoparticles as desired. For instance, optically passive layers can be grown as an outer shell or between layers containing active ions. Additional layers can optionally include optically active ions that can be the same or different from the optically active ions of other layers.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures in which:

FIG. 1 schematically illustrates an exemplary core/shell nanoparticle of the invention;

FIGS. 2A-2D schematically illustrate four different architectures for exemplary core/shell nanoparticles of the present invention;

FIG. 3 illustrates the emission spectra for an excitation at 375 nm of single-doped nanoparticles as well as a 1:1 blend of the two single doped nanoparticles;

FIG. 4 illustrates the emission spectra for an excitation at 350 nm of Lanthanum Fluoride nanoparticles doped with Europium and Terbium in varying architectures, including core/shell nanoparticles as illustrated in FIG. 2;

FIG. 5 is a map of the emission spectra of single-doped Europium-doped Lanthanum Fluoride (Eu_{.2}La_{.8}F₃) nanoparticles (FIG. 5A) and that of Terbium-doped Lanthanum Fluoride (Tb_{.2}La_{.8}F₃) nanoparticles (FIG. 5B);

FIG. 6 is a map of the emission spectra of co-doped Europium and Terbium doped Lanthanum Fluoride nanoparticles (Eu_{.2}Tb_{.2}La_{.6}F₃) (FIG. 6A) and that of a blend of single material-doped nanoparticles (FIG. 6B);

FIG. 7 is a map of the emission spectra of layered nanoparticles of the present invention including a first architecture having a Tb_{.2}La_{.8}F₃ core, a first shell of Eu_{.2}La_{.8}F₃, and an outer shell of LaF₃ (FIG. 7A), and the map of the emission spectra of core/shell nanoparticles of a second architecture including an Eu_{.2}La_{.8}F₃ core, a first shell of approximately 1 nm of LaF₃, a second shell of Tb_{.2}La_{.8}F₃, and an outer shell of LaF₃ (FIG. 7B); and

FIG. 8 is a map of the emission spectra of a core/shell nanoparticle of the present invention including an Eu_{.2}La_{.8}F₃ core, a first shell of approximately 2 nm of LaF₃, a second shell of Tb_{.2}La_{.8}F₃, and an outer shell of LaF₃.

### DETAILED DESCRIPTION OF REPRESENTATIVE EMBODIMENTS

Reference will now be made in detail to various embodiments of the invention, one or more examples of which are illustrated in the accompanying Figures. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention cover such modifications and variations as come within the scope of the appended claims and their equivalents.

### Definitions

“Nanoparticle” refers to a particle having a dispersed particle size less than about 100 nanometers (nm). While nanoparticles can be spherical, this is not a requirement of the term, and nanoparticles of any shape are encompassed by the definition.

“Layered nanoparticle” refers to a nanoparticle including adjacent materials that differ from one another according to at least one physical and/or chemical characteristic. Adjacent layers of a layered nanoparticle can be either continuous or discontinuous across one another.

“Core/shell nanoparticle” refers to a layered nanoparticle including an inner layer (i.e., a core) encapsulated by a single or a combination of outer layers (i.e., shells). An individual layer of a core/shell nanoparticle can be either the core of the nanoparticle or a single shell of the nanoparticle.

“Active ions” refers to any ion that can absorb optical energy and, in response, emit energy at the same or other wavelength. In one particular embodiment, active ions can be rare earth elements, but the term is not intended to be limited to rare earth elements, and other active ions, such as transition metals, are also encompassed by the term. The ability of “active ions” to absorb and emit light is heretofore referred to as their being “optically active” which is not to be confused with the “optical activity” (or “optical rotatory power) of chiral materials to rotate a plane of polarization.

### DETAILED DESCRIPTION

The present invention is directed to optically active layered nanoparticles, methods of making the layered nanoparticles, and methods of using the layered nanoparticles. The layered nanoparticles include multiple active ions in an architecture so as to provide controlled energy transfer between the different ions. More specifically, each active ion can be provided in a discrete layer of the nanoparticle. Through design of the components and/or architecture of the individual layers of the nanoparticle and their relative position to one another, energy transfer between the active ions can be controlled. In particular, multiple active ions can be contained within the nanoparticles so as to provide zero, partial, or complete energy transfer between the active ions.

While much of the following discussion is directed to core/shell nanoparticles, it should be understood that the present invention is not limited to core/shell-type layered nanoparticles, and any nanoparticle including multiple layers is encompassed by the invention. For example, layered nanoparticles comprising a flatter multi-layered geometry, e.g., a sandwich-type geometry, are another example of a layered nanoparticle of the present invention.

Each layer of the nanoparticles can include an optically transparent base material. For example, the nanoparticles can include the same optically transparent base material in every layer, with adjacent layers varying from one another as to the presence or type of dopant(s) included in the layers. In other embodiments, however, the optically transparent base material of adjacent layers can vary.

In general, the base material of the individual layers of the nanoparticle can include any optically transparent inorganic material capable of being doped with one or more active ions. Suitable inorganic materials include ceramic materials such as oxides, halides, oxyhalides and chalcogenides of metals such as lanthanum (La), lead (Pb), zinc (Zn), cadmium (Cd), and the Group II metals, e.g., beryllium (Be), magnesium (Mg), calcium (Ca), strontium (Sr) and barium (Ba). Group III metal ceramics can also be used, such as aluminosilicates. Group IV and Group V semiconductor elements and Group III-V, Group II-V and Group II-VI semiconductor compounds may also be used, including, but not limited to, silicon (Si), arsenic (As), gallium (Ga), gallium arsenide (GaAs), gallium nitride (GaN), indium nitride (InN) and the like.

In one embodiment, the nanoparticles can be synthesized from an aqueous solution. According to this embodiment, a solution containing an anion of an optically transparent halide salt can be formed, for instance by dissolving in aqueous solution an excess of an ammonium halide, e.g., ammonium fluoride.

A cation-containing solution including the metal cation of a halide salt can then be combined with the anion solution according to any suitable method, thereby nucleating the metal halide salt. For example, halide salts of metals such as, without limitation, beryllium (Be), magnesium (Mg), calcium (Ca), strontium (Sr), barium (Ba), or lanthanum (La) can be dissolved in water to form a cation-containing solution. For example, BeCl₂, MgCl₂, CaCl₂, SrCl₂, BaCl₂ or LaCl₃, or their hydrates, can be dissolved in triply-deionized water at a temperature at which the salt will dissolve, typically from about 20° C. to about 90° C.

In those embodiments in which the layer (e.g. the core) includes an optically active dopant, the cation-containing solution can also include one or more optically active ion dopants, for instance one or more rare earth elements. The active ion can be added to the solution as a stoichiometric quantity of a water-soluble salt of the desired active ion at the desired level of doping. Rare earth element halide salts, for example, chloride or nitrate salts, can be used. For example, halide salts of dysprosium (Dy), holmium (Ho), erbium (Er), europium (Eu), terbium (Tb), thulium (Tm), ytterbium (Yb), praseodymium (Pr), neodymium (Nd), samarium (Sm), or gadolinium (Gd) can be used. However, any active ion elements as herein defined can be used alone or in combination, and with or without other active ion species.

It should be understood, however, that the two cations (the dopant and the base material metal cation) need not be provided in a single solution to form a doped metal halide compound. For example, a doped layer can be formed through utilization of two cation-containing solutions, the first including the metal of the base material halide salt, and the second containing the active ion dopant. These two solutions can be combined prior to combination with the anion-containing solution or can be added simultaneously or intermittently to the anion-containing solution to form a doped metal halide salt layer. The utilization of two separate solutions does entail the formation of the solutions and addition of the solutions to the anion-containing solution at the proper concentration so as to provide the doped reaction product with the desired dopant concentration. Such formation and addition methods are generally known to those of ordinary skill in the art, however, and thus need not be discussed at length herein.

The cation-containing solution(s) can be added slowly, e.g., drop-wise, to the anion-containing solution, and the compound that will form the core of the nanoparticle can nucleate. Following initial nucleation, the nanoparticle core can continue to grow as long as the reagents are available and the reaction continues. The size of the core will be proportional to the amount of reactant available, as is generally known in the art. Accordingly, the limiting reagent, e.g., the cation, can be added so as to control the size of the layer, e.g., the diameter of the core.

A first shell can be grown on the nanoparticles with the addition to the anion-containing solution of additional cation. Specifically, a second cation-containing solution can be added to the anion-containing solution following initial formation of the nanoparticle core, and a shell can grow on the core. Optionally, additional anion can be added to the solution as well, for instance to maintain desired levels of excess anion in solution. The cation solution (or combination of solutions) provided to the reaction during formation of the first shell can differ in content from those provided during the formation of the core. For example, the cations provided to the reaction during formation of the shell can differ from those provided during formation of the core by the presence or type of dopant, by the relative concentration of dopant, by the metal cation of the halide salt provided, or by any combination thereof. Thus, the compound forming the first shell will differ in some manner from that forming the core. As with the diameter of the core, the thickness of the shell will be proportional to the amount of cation added to the anion-containing solution, and shell thickness can thereby be controlled.

Subsequent shells can be developed in a like manner and a layered nanoparticle including multiple layers can be grown. Subsequent layers, while they will differ from immediately adjacent layers, can be the same or different as materials forming other layers in the nanoparticle. For example, the material of the core can also form an outer shell of the nanoparticle.

According to the present invention, the architecture of the nanoparticle can be designed and utilized to control the energy transfer between dopants included in discrete layers of the nanoparticles. For example, a first dopant can be included in the core of a core/shell nanoparticle, and a second dopant can be included in a shell. In one embodiment, the shell including the second dopant can be formed immediately adjacent to the core. Hence, in this embodiment, large levels of energy transfer can occur between the two dopants, for instance the magnitude of the energy transfer can be equal to that of co-doped dopants, and the emissive characteristics of the nanoparticle can reflect that large amount of energy transfer.

In another embodiment, the architecture of the nanoparticle can be designed so as to provide for less energy transfer between the dopants. According to this embodiment, the layers including the two dopants can be separated from one another by one or more intervening layers and, depending upon the thickness of the intervening layer(s), partial or no energy transfer can occur between the dopants.

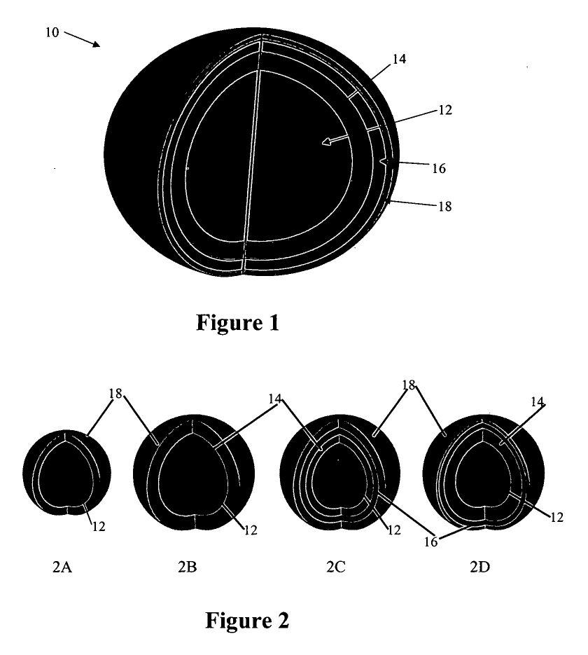

Referring to FIG. 1, one embodiment of a core/shell nanoparticle 10 of the present invention is illustrated. As can be seen, the nanoparticle includes an inner core 12, a first shell 14, a second shell 16, and an outer shell 18. According to one embodiment, the inner core 12 can include a first optically active ion and the second shell 16 can include a second optically active ion. The intervening shell 14, can be formed of an optically passive material, for instance an un-doped optically transparent halide salt. The amount of energy transfer between the two dopants in layers 12 and 16 can vary with the thickness of this intervening passive layer.

The relationship between the amount of energy transfer between the dopants and the thickness of the intervening layer can generally vary depending upon the specific materials involved. For example, in one particular embodiment, a passive LaF₃ layer 14 of about 2.2 nm can be located between a first active layer 12 and a second active layer 16, each including a rare earth dopant. The presence of layer 14 can limit or totally prevent energy transfer between the two dopants, and a single or multiple excitation sources can excite both ions with little emission loss due to energy transfer between the dopants. The particular relationship between distance and amount of energy transfer between different active ions can depend upon the nature of the transition. As such information is generally known to those of skill in the art, a detailed discussion of the phenomenon is not included here. For example, a layered nanoparticle can be formed including an optically passive layer of about 2 nm between two optically active layers. This nanoparticle can produce emission spectra equivalent to the spectrum of a blend of single-doped nanoparticles. The thickness of a passive layer to produce such an effect can vary, however, depending upon the characteristics of the materials included in the nanoparticle.

According to the invention, the architecture of the nanoparticles can be designed so as to promote any desired amount of energy transfer, i.e., zero, partial, or complete energy transfer, between dopants included in the layered nanoparticles. As such, the emission spectra of the nanoparticles can also be controlled.

In contrast to current methods for restricting energy transfer between multiple dopants, which utilizes a blended mixture of single-doped nanoparticles, the nanoparticles of the present invention can provide greatly improved homogeneousness to the materials, as the blending of chemically different particles is no longer necessary, and every particle can emit a broad spectral range provided by the combined spectra of the multiple active ions.

Referring again to FIG. 1, it may be preferred in some embodiments to form an outer shell 18 of an optically passive material on the nanoparticles. For instance an outer shell of an un-doped halide salt, an optically transparent semi-conductor, or the like can be included. A passive outer shell on the nanoparticles can mitigate problems encountered in the past in which lanthanide emission can be quenched. This effect is believed to be due to the high surface area of nanoparticles upon which a large fraction of the active ions can reside and thus be prone to quenching from adsorbed species such as hydroxide.

Following growth of the shells, the core/shell nanoparticles can be concentrated from the solution. A separate concentration step in order to crash out the suspension is not a requirement of the invention, however. For example, when the halide is a fluoride, a concentration step may not be necessary, as fluorides are generally less dispersible in solution than other halide salts. For highly dispersible halides such as chlorides and higher halides, concentration of the nanoparticles can be obtained by adding a polar organic solvent such as ethanol to the solution in a quantity effective to concentrate the core/shell nanoparticles.

The nanoparticles can be washed with water, for instance with triply-deionized water, to remove any by-products. The particles can also be subjected to centrifugation to ensure complete removal of any by-products.

According to a second synthesis method, layered nanoparticles can be formed through reactive atmosphere treatment of layered metal hydrous oxide nanoparticles, for example via reaction with a halogenating gas.

According to one embodiment of this process, water-soluble salts of a halide-forming metal cation can be dissolved in water at a temperature at which the salts will dissolve. For example, a salt of lanthanum (La), lead (Pb), zinc (Zn), cadmium (Cd) or a metal of Group II, i.e., beryllium (Be), magnesium (Mg), calcium (Ca), strontium (Sr) or barium (Ba), can be dissolved in water, typically water between about 20° C. and about 90° C.

When forming a layer of the nanoparticle including an optically active ion, the cation-containing solution can also include a stoichiometric quantity of one or more water-soluble salts of the desired active ions at the desired level of doping. Optionally, a separate solution including the active ion can be utilized, however, as discussed above.

The cation-containing solution(s) can be slowly added, e.g., drop-wise, to a solution containing a stoichiometric excess of NH₄OH or other suitable hydroxide, and nucleation of the core of hydrous oxide core/shell nanoparticles can occur. Similar to the direct formation methods described above, subsequent shells can be grown on the nanoparticles by varying the cations added to the solution over the course of the formation process. The hydrous oxide nanoparticles can then be concentrated from solution as oxides, hydrous oxides and hydroxides. The nanoparticles can be washed with water, e.g., triply-deionized water, to remove ammonium halide reaction by-product. The nanoparticles can be washed several times and then dried, for instance by heating at about 90° C. for about 24 hours. By-product can optionally be removed by any other suitable method however, including a sublimation process.

Following formation of the hydrous oxide nanoparticles, the nanoparticles can be subjected to reactive atmospheric processing to halogenate the materials forming the layers of the nanoparticles. For instance, the nanoparticles can be placed in an oven, for example a muffle-tube furnace. The oven can be purged with inert gas and then heated at a rate between about 1° C./minute and about 50° C./minute, for instance at about 10° C./minute, to a temperature at which halogenation of the hydroxides can occur without melting the lowest melting point component of the nanoparticles. For example, and depending upon the specific materials included in the nanoparticles, the hydroxides can be heated to a temperature between about 100° C. and about 600° C., for instance between about 200° C. and about 300° C.

The hydrogen halide corresponding to the halide salts to be formed can then be introduced into the oven, for instance via a nitrogen flow in a gas mixture. For example, to form a nanoparticle including discrete layers of metal fluoride salts including one or more layers doped with optically active ions, hydrogen fluoride can be introduced into the nitrogen flow. Similarly, to form a nanoparticle including layers of metal chloride salts, hydrogen chloride can be introduced into the nitrogen flow. Other halogenation gases may be used as well, including aprotic gases such as sulfur hexafluoride (SF₆) or nitrogen trifluoride (NF₃). Hydrogen sulfide (H₂S) may be used to form metal sulfides. Other chalcogenides can be formed using related hydrogen compounds, as is generally known in the art.

During the reaction, the nanoparticle materials can quantitatively convert to the respective halide. Depending upon the quantity of hydrogen halide used, a halide or oxyhalide compound is formed. Depending upon the temperature at which the oven is heated, the conversion generally takes place within about one-half to about two hours, after which the introduction of the hydrogen halide to the nitrogen flow can be discontinued and the oven can be cooled to room temperature under a flowing nitrogen atmosphere.

Any other method presently known or not yet developed can alternatively be utilized for forming the layered nanoparticles of the present invention. The preparation of nanoparticle-sized active ion doped oxides, chalcogenides and Group III-V, Group II-V and Group II-VI semiconductor compounds and Group IV and Group V semiconductor elements is known to those skilled in the art. Oxides, for example, including aluminosilicates, can be made by hydrothermal methods, flame oxidation methods, plasma synthesis methods, the hydrolysis and polymerization of metal alkoxides, and by microemulsion precipitation. Related techniques can be used to prepare layered nanoparticle-sized chalcogenides including discrete layers containing optically active dopants.

The layered nanoparticles of the present invention can have a size between about 1 nm and about 100 nm, for instance between about 5 nm and about 15 nm, and in one embodiment between about 15 nm and about 25 nm. In general, the core of a core/shell nanoparticle can be between about 1 nm and about 7 nm, and the shells can be between about 0.25 nm and about 3 nm, with preferred shell thickness depending upon the materials forming the shell as well as the function of the shell, as discussed above. Halide materials forming the nanoparticles can contain oxygen and still exhibit luminescent properties characteristic of high-quality optical materials.

Individual layers of the nanoparticles can contain between about 1 and about 99 mole percent active ion dopant. In one embodiment, active ion levels of about 60 mole % can be attained in a single layer of the nanoparticles, however, layers can include dopant at other levels, including parts per thousand, parts per million or parts per billion levels, in part due to the optical transparency capable of being attained in the nanoparticles.

In many applications, the nanoparticles can be components of a composite material. For example, the nanoparticles can be dispersed in a carrier matrix to form a composite material. In one embodiment, the matrix can be chemically inert to the dispersed nanoparticles, i.e., the materials forming the nanoparticles will not cause the chemical degeneration of the matrix materials. Many suitable matrix materials and methods for dispersing particulate material therethrough are known in the art. For example, dispersions in glass and polycrystalline matrices can be prepared according to known sol-gel processes, as well as by conventional powder and melt techniques, and solid and viscous sintering processes, all of which include processing the formed nanoparticles with the matrix materials.

Possible matrix materials can include, without limitation, glass, crystalline materials and polymeric materials. Inert, optically transparent liquids can also be used such as THF, DCM, chloroform, water, alcohol, DSMO, etc. Polymeric materials can be preferred in some applications due to their inertness toward active ion doped nanoparticles and their low processing temperatures. The matrix material can have excellent optical transparency at wavelengths at which excitation, fluorescence or luminescence of the active ions occur. The matrix material can also exhibit good film-forming characteristics. In one embodiment, composite materials of to the present invention can have an attenuation of less than 100 decibels per centimeter (dB/cm). In another embodiment, a composite material of the invention can have an attenuation of less than 10 dB/cm, for example less than 1 dB/cm. Other properties will come into consideration, depending upon the particular end-use requirements of the materials; however, these properties are well understood by those of ordinary skill in the art.

A non-limiting list of possible of crystalline matrix materials can include yttrium oxide, aluminum oxynitride, and the like. Polymeric matrix materials particularly suitable for applications in infrared wavelengths can include fluoropolymers such as poly(vinylfluoride), poly(vinylidene fluoride), perfluorocyclobutyl polymers and copolymers, fluorinated polyimides, CYTOP® amorphous fluoropolymers available from Bellex International Corp. (Wilmington, Del.), TEFLON® AF (an amorphous poly(vinylfluoride)), TEFLON® PFA (a perfluoroalkoxy copolymer), both available from DuPont™, and the like. Other possible matrix polymers can include acrylates (e.g., polymethyl methacrylate, halogenated acrylates), benzo-cyclobutenes, polyetherimides, siloxanes such as deuterated polysiloxanes, and the like.

A dispersion of nanoparticles into the matrix material to form the composite can generally be performed at a temperature at which the nanoparticle remains a separate phase within the matrix, which is readily apparent to one of ordinary skill in the art.

The layered nanoparticles and composite materials including the nanoparticles can be employed to produce a variety of useful articles with valuable optical properties. The composites can be readily processed by conventional techniques to yield optical fibers, bulk optics, films, monoliths, and the like. Optical applications thus include the use of the composite materials to form the elements of zero-loss links, upconversion light sources, white light or multi-color light emitters, volumetric displays, flat-panel displays, sources operating in wavelength-division-multiplexing schemes, optical limiters and amplifiers, including broad-band amplifiers, improved solar cells, and the like.

The present invention may be better understood by reference to the following examples:

### EXAMPLE

Synthesis: A solution of 614 milligrams (mg) of ammonium di-n-octadecyldithiophosphate (ADDP) and 126 mg of NH₄F in 70 milliliter (mL) ethanol/water was heated to 75° C. A 2 mL aqueous solution with total molar Ln(NO₃)₃ concentration of 1.33 millimole (mmol) was then added drop-wise to the stirring fluoride solution to form the core of the particles. After stirring for 10 minutes, the first shell was grown by the alternating addition in 10 parts of a 2 mL aqueous NH₄F (126 mg) solution and a 2 mL aqueous Ln(NO₃)₃ solution with total molar concentration of 1.33 mmol. The composition of the Ln(NO₃)₃ solution will be the composition of the shell. In this work, Eu(NO₃)₃ and/or Tb(NO₃)₃ were used as dopants at 20 mol % concentrations (i.e., Eu_{.2}La_{.8}F₃ and Tb_{.2}La_{.8}F). The process was repeated for each shell with variation in reactants as to content and/or presence of dopant. After the formation of the last shell, the solution was stirred for an additional 2 hours and cooled to room temperature. Following cooling, the particles were cleaned by washing in ethanol and water, followed by dispersing in 5 mL dichloromethane, and precipitating with the addition of 20 mL of ethanol. The resultant powder was dried for 2 days over P₂O₅ in a desiccator. The particles were dispersed in tetrahydrofuran for measurements.

FIGS. 2A-2D show schematic illustrations of four different core/shell architectures that were developed. The first structure (FIG. 2A) is the simple core/shell nanoparticle. In this particle, the outermost LaF₃ shell 18 served to prevent quenching and undesirable energy transfer with the host matrix. The next three models (FIGS. 2B-2D) show complex core/shell structures with varying relative thicknesses of an undoped LaF₃ layer between the doped shells. This layer served to control the energy transfer between doped layers by separating the ions by a prescribed distance. Calculated layer thicknesses were used to describe the different complex core/shell architectures. These thicknesses were calculated by assuming that the ratio of the volume of material added for the growth of a layer was equal to the ratio of the volume for each layer. Particle size has previously been shown to increase when a shell is added to nanoparticles using the same general procedure (see, e.g., Stouwdman, et al., F. C. J. M. (2004) Langmuir 20, 11763-11771). With the ratio of the volumes of each shell, the average particle size was used to calculate the total volume of an average particle and from this the average thickness of each shell. Table 1, below, details the architecture of each of the nanoparticles formed and illustrated as FIGS. 2A-2D. Shell thickness shown on the table and core diameter are approximate. For comparison purposes, simple Europium-doped (Eu_{.2}La_{.8}F₃) and Terbium-doped (Tb_{.2}La_{.8}F₃) and co-doped Eu_{.2}Tb_{.2}La_{.6}F₃ nanoparticles, having no outer shell, were also formed with an average diameter approximately 7 nm.

TABLE 1

| | | First Shell | Second Shell | Outer Shell |
|---|---|---|---|---|
| Figure | Core (12) | (14) | (16) | (18) |
| 2A | Eu_{.2}La_{.8}F₃ | | | LaF₃ |
| 2B | Tb₂La_{.8}F₃ | Eu₂La_{.8}F₃ | | LaF₃ |
| 2C | Eu_{.2}La_{.8}F3 | LaF₃ (1 nm) | Tb_{.2}La_{.8}F₃ | LaF₃ |
| 2D | Eu_{.2}La_{.8}F₃ | LaF₃(2 nm) | Tb_{.2}La_{.8}F₃ | LaF₃ |

Photoluminescence measurements were performed with a Jobin Yvon Fluorolog-3 spectrofluorometer with a double grating configuration with an excitation bandpass of 2 nm and a scan rate of 60 nm/min. TEM was performed on a Hitachi H9500 operating at an acceleration voltage of 300 kV. X-ray diffraction was performed with a Scintag XDS 4000 using Cu Kα radiation. X-ray fluorescence was performed with a Thermo Noran QuanX EC Energy Dispersive X-Ray Fluorescence Spectrometer using a Fundamental Parameters Model to quantify the data. The La, Eu, and Tb were measured at 20 Kv with a Pd filter in air. P and S were measured at 8 kV with no filter in air. Data was acquired for 100 seconds (at 50% Deadtime) for each excitation condition. LaF₃, Eu₂O₃, Tb₄O₇, NH₄H₂PO₄ and (NH₄)₂SO₄ were used as peak shape characterization standards for the Fundamental Parameters Model.

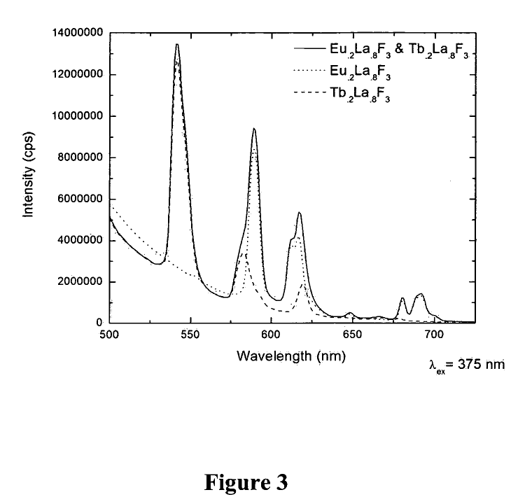

The excitation spectra of the 541 nm Tb⁺³ and the 590 nm Eu⁺³ emissions for separate individually doped LaF₃ nanoparticles (i.e., Tb_{.2}La_{.8}F₃ and Eu_{.2}La_{.8}F₃) were measured as was a 1:1 blend of the two single-doped particles. An excitation wavelength of 375 nm was chosen for the emission spectra since it would excite both the Tb_{.2}La_{.8}F₃ and Eu_{.2}La_{.8}F₃ nanoparticle liquids as well as the 1:1 blend. FIG. 3 illustrates the results. As can be seen, the luminescence spectrum of the blended nanoparticle solution was approximately the sum of the peak intensities of the two “pure” nanoparticle emissions. When Tb⁺³ and Eu⁺³ were co-doped into a particle, the Tb⁺³ transferred its energy to the Eu⁺³ ion. The presence of the 541 nm peak in FIG. 3 indicated that there was no significant energy transfer between lanthanide ions when the singularly doped nanoparticles are blended.

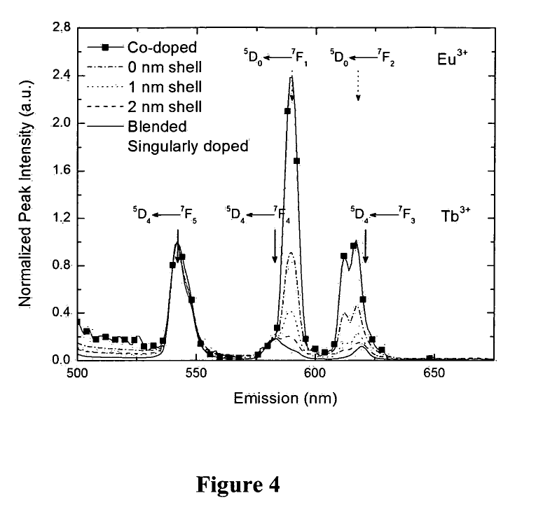

The spectra for the co-doped nanoparticles, the 1:1 blend of single-doped particles and the complex core/shell particles described in Table 1 are shown in FIG. 4 for an excitation at λ=350 nm. This excitation wavelength was chosen as Tb⁺³ has a strong absorption and Eu⁺³ has a negligible excitation which allows for the direct inference of energy transfer. Referring to FIG. 4, it can be seen in the co-doped simple core-shell nanoparticles that there was a strong emission peak at 590 and 615 nm. These emissions correspond to the ⁵D₀→⁷F₁ and ⁵D₀→⁷F₂ transitions of Eu⁺³, respectively, and confirm the Tb⁺³-to-Eu⁺³ energy transfer that arises when Eu⁺³ and Tb⁺³ are co-doped together. These samples were also excited at 480 nm (not shown) corresponding to the ⁵D₄ level of Tb⁺³ and high intensity emission from the Eu⁺³ where observed further corroborating that energy transfer occurs from the ⁵D₄(Tb) to the ⁵D₁(Eu). The peak intensities of the ⁵Dₒ→⁷F_{J} emissions can be seen in FIG. 4 to decrease. In order to test effects that were due to the dopants position in the core-shell architecture, nanoparticles were synthesized that had a Tb⁺³ in the core and a Eu⁺³ in the shells (Particles 2B in Table 1) as well as Eu⁺³ in the core and Tb⁺³ in the shells. The emission spectra of these two types of nanoparticles were found to be the same (not shown). It can therefore be concluded that there are no major effects due to the order of the order of a dopants position within a nanoparticles but only due to a dopants position with respect to another dopant.

Complex core-shell nanoparticles with a ca. 1 nm thick LaF₃ shell grown between the lanthanide doped layers (Particles 2C on Table 1) exhibited a 60% decrease in the ⁵Dₒ→⁷F_{J} intensity. The thickness of the LaF₃ layer separating the Eu_{.2}La_{.8}F₃ core and Tb_{.2}La_{.8}F doped shell was increased to ca. 2 nm (Particles 2D on Table 2) which resulted in a decrease of the integrated area of the ⁵Dₒ→⁷F_{J} peaks by greater than 90%. It can be seen that there is a substantial decrease in the Eu⁺³ emissions as the shell thickness approaches 2 nm. At this thickness, the Eu⁺³ emissions are only slightly more intense than the emission spectrum of a blend of singularly doped particles, indicating that there is a small amount of energy transfer.

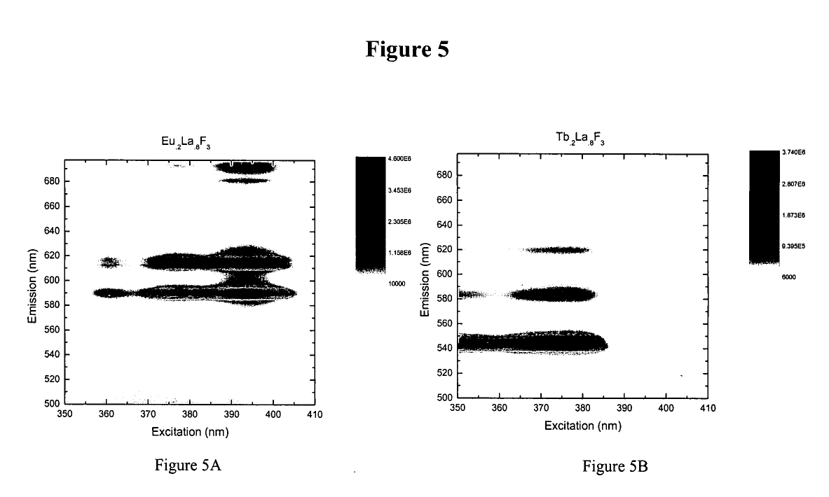

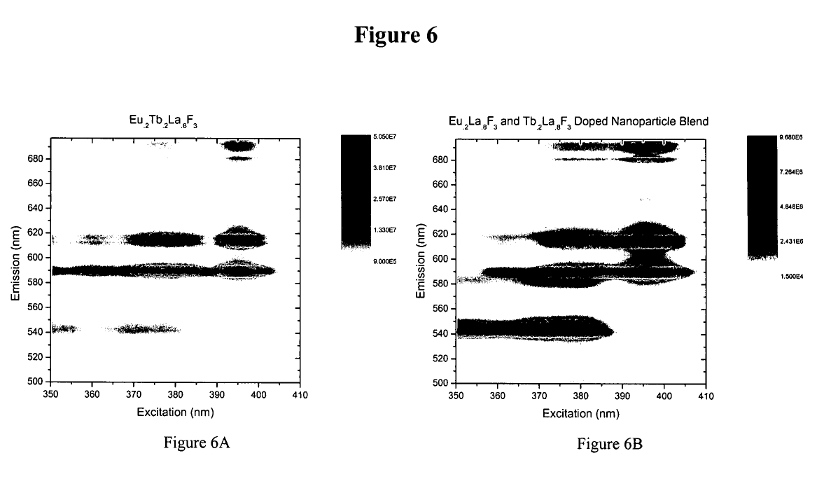

FIGS. 5A and 5B are the emission maps obtained from the single doped Eu⁺³ and Tb⁺³ nanoparticles, respectively. FIGS. 6A and 6B are the emission maps of the co-doped particles and the 1:1 mixture of the single doped particles, respectively. As can be seen, the Tb⁺³ emission is diminished in the co-doped particles (FIG. 6A) due to the energy transfer from the Tb⁺³ to the Eu⁺³. In the blend of single dopant nanoparticles (FIG. 6B), there is little interaction observed. As in FIG. 3, the emission spectra is approximately the sum of the two separate spectra.

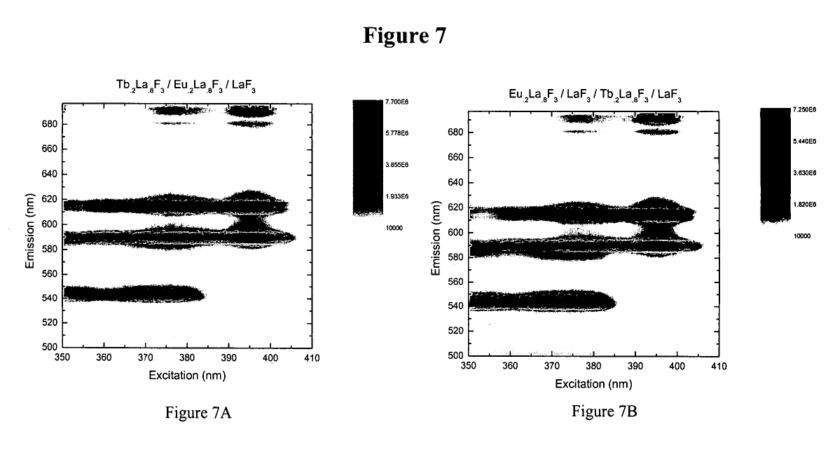

FIG. 7A illustrates the emission map of particles that contain both dopants in immediately adjacent layers (particles 2B from Table 1). While the intensity of the 540 nm emission from the Tb⁺³ has increased as compared to the co-doped particles (FIG. 6A), the 615 nm double peak of the Eu⁺³ is still clearly visible and effects of energy transfer at 350 nm.

In FIG. 7B, the emission spectra from particles including an ˜1 nm passive LaF₃ layer between the Eu⁺³ doped core and the Tb⁺³ doped layer (particles 2C on Table 1) is mapped. The inclusion of the passive intervening layer decreased the amount of energy transfer as compared to the nanoparticles with no intervening layer illustrated in FIG. 7A. As can be seen, the Tb⁺³ emission has increased.

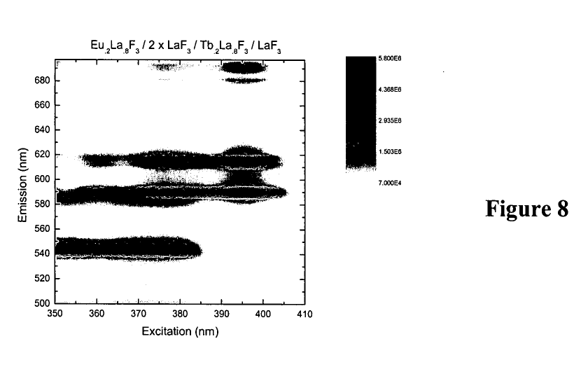

In FIG. 8, the emission spectra of the particles having the larger intervening passive layer was mapped (particles 2D from Table 1). The results obtained are close to those of the blended single-doped nanoparticles shown in FIG. 6B, suggesting that at this distance, energy transfer between the two dopants can be prevented.

By use of core/shell nanoparticles with 3 shells, the ratio of the 540 nm Tb⁺³ peak to that of the 590 Eu⁺³ peak has been varied from 0.2 to 2.4 in the emission spectra of the nanoparticles. This variation in emission spectra was accomplished without changing the overall composition or external dimensions of the particles but only the internal structure. Beyond simply varying the emission spectra, however, the excitation spectra of active ions can be altered by allowing active ions to act as sensitizers and emitters. The highly structured particles of the invention including multiple layers and multiple dopants with controlled energy transfer between dopants can have uses in, e.g., white light emitters, multicolor displays, lasers, and broadband amplifiers where multiple emissions are desired from a single excitation wavelength.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A layered nanoparticle comprising a first optically active ion within a first layer of the layered nanoparticle and a second optically active ion within a second layer of the layered nanoparticle, wherein the first layer and the second layer are at a predetermined location with respect to one another, wherein energy transfer between the first optically active ion and the second optically active ion is controllably determined according to the predetermined location of the first layer and the second layer.

2. The layered nanoparticle of claim 1, wherein the layered nanoparticle is a core/shell nanoparticle.

3. The layered nanoparticle of claim 2, wherein the first layer is the core of the nanoparticle.

4. The layered nanoparticle of claim 1, wherein the first active ion and the second active ion are rare earth elements.

5. The layered nanoparticle of claim 1, the first layer further comprising a first optically transparent base material, wherein the first optically active ion is a dopant of the first optically transparent base material.

6. The layered nanoparticle of claim 5, wherein the optically transparent base material is a halide salt.

7. The layered nanoparticle of claim 5, the second layer further comprising a second optically transparent base material, wherein the second optically active ion is a dopant of the second optically transparent base material.

8. The layered nanoparticle of claim 7, wherein the first optically transparent base material and the second optically transparent base material are the same.

9. The layered nanoparticle of claim 1, wherein the first layer and the second layer are immediately adjacent to one another.

10. The layered nanoparticle of claim 1, the nanoparticle further comprising a third layer between the first layer and the second layer, wherein the third layer is an optically passive layer.

11. The layered nanoparticle of claim 10, wherein the third layer is an optically transparent halide salt.

12. The layered nanoparticle of claim 10, wherein the third layer is greater than about 2 nanometers in thickness.

13. The layered nanoparticle of claim 10, wherein the third layer is less than about 3 nanometers in thickness.

14. The layered nanoparticle of claim 13, wherein the third layer is less than about 1 nanometer in thickness.

15. The layered nanoparticle of claim 1, further comprising one or more additional layers.

16. The layered nanoparticle of claim 15, wherein the one or more additional layers include one or more optically active layers.

17. A composite material comprising:
a layered nanoparticle comprising a first optically active ion within a first layer of the layered nanoparticle and a second optically active ion within a second layer of the layered nanoparticle, wherein the first layer and the second layer are at a predetermined location with respect to one another, wherein energy transfer between the first optically active ion and the second optically active ion is controllably determined according to the predetermined location of the first layer and the second layer; and
a matrix encapsulating the layered nanoparticle.

18. The composite material of claim 17, the first layer of the layered nanoparticle further comprising a first optically transparent base material, wherein the first optically active ion is a dopant of the first optically transparent base material.

19. The composite material of claim 18, the second layer of the layered nanoparticle further comprising a second optically transparent base material, wherein the second optically active ion is a dopant of the second optically transparent base material.

20. The composite material of claim 19, wherein the first optically transparent base material and the second optically transparent base material are halide salts.

21. The composite material of claim 17, the layered nanoparticle further comprising a third layer between the first layer and the second layer, wherein the third layer is an optically passive layer.

22. The composite material of claim 17, wherein the matrix is an optically transparent crystalline material.

23. The composite material of claim 17, wherein the matrix is a glass.

24. The composite material of claim 17, wherein the matrix is a polymeric matrix.

25. The composite material of claim 17, wherein the polymeric matrix comprises a fluoropolymer.

26. A method of forming a layered nanoparticle comprising:
combining in an aqueous solution an anion, a first cation, and a second cation, wherein the second cation is an optically active ion;
growing a first layer of a layered nanoparticle, the first layer comprising the reaction product of the reaction between the anion, the first cation, and the second cation;
combining in the aqueous solution the anion, a third cation, and a fourth cation, wherein the fourth cation is an optically active ion;
growing a second layer on the layered nanoparticle, the second layer comprising the reaction product of the reaction between the anion, the third cation, and the fourth cation.

27. The method according to claim 26, wherein the first cation and the third cation are each a metal cation of a halide salt.

28. The method according to claim 27, wherein the first cation and the third cation are the same.

29. The method according to claim 26, wherein the second cation and the fourth cation are rare earth elements.

30. The method according to claim 26, wherein the anion is a halogen.

31. The method according to claim 26, wherein the anion is a hydroxide.

32. The method according to claim 31, further comprising halogenating the layered nanoparticle.

33. The method according to claim 26, further comprising growing a third layer on the layered nanoparticle, wherein the third layer is optically passive.

34. The method according to claim 33, wherein the third layer is between the first layer and the second layer.
